(19) United States
(12) Patent Application Publication
(10) Pub. No.: US 2019/0086044 A1
(43) Pub. Date: Mar. 21, 2019

(54) RECESSED LIGHT FIXTURE

(71) Applicant: GE Lighting Solutions, LLC, East Cleveland, OH (US)

(72) Inventors: Min FANG, Shanghai (CN); Shuyi QIN, Shanghai (CN); Qi LONG, Shanghai (CN); Honglei GAO, Shanghai (CN); Yong LI, Shanghai (CN)

(21) Appl. No.: 15/748,673

(22) PCT Filed: Jul. 29, 2016
(86) PCT No.: PCT/CN2016/092196

§ 371 Date: Nov. 27, 2018

(30) Foreign Application Priority Data
Jul. 30, 2015 (CN) 201510458506.1

(51) Int. Cl. F21S 8/02; F21V 21/04; F21V 17/18; F21V 15/01

(52) U.S. Cl. CPC F21S 8/026; F21V 21/04; F21V 17/104; F21V 15/01; F21V 17/18

(57) ABSTRACT

The present invention provides a recessed light fixture comprising a housing and a bottom plate, wherein the housing is composed of a first side wall and a second side wall opposite to each other, with both the first side wall and the second side wall are respectively provided with a first latching portion and a second latching portion, and the bottom plate is a light diffuser plate or a ventilation plate. The bottom plate comprises a first edge and a second edge opposite to each other. By engaging at least a portion of the first and second edges with the first and second latching portions respectively, the bottom plate can be assembled directly onto the housing while preventing it from moving up or down. The present invention solves the problem of complex and time consuming assembly of currently used recessed light fixture housings and bottom plates, and possesses the advantages of a simpler structure, convenient assembly, as well as a vast reduction in the number of parts and components.

### TECHNICAL FIELD

The present invention relates to the technical field of lighting, in particular to that of a recessed light fixture with a novel structure for a housing and a bottom plate.

### BACKGROUND ART

Recessed light fixtures refer to light fixtures where the body structure of the light fixture is recessed into the building or other objects after installation and are not visible, such as lighting installed into indoor ceilings. Existing recessed light fixtures generally include a housing, a bottom plate, a light source and a driving portion. Generally, the housing has an opening and the bottom plate may functionally be a light diffusion plate or a ventilation plate, which is generally in the form of a flat plat or having a certain curvature. During the assembly process of the light fixture, the light source and the driving portion are first installed inside the housing, then the bottom plate is assembled onto the opening of the housing to achieve a seal. Taking a recessed light fixture with a rectangular opening as an example, the housing generally comprises an upper substrate and four side walls, a box-shaped structure with an opening facing downwards, with the bottom plate being a rectangular flat plate of substantially the same dimension as the opening of the housing. One method of assembling the bottom plate onto the housing is to use the four borders to compress the edges of the bottom plate with the edges of the four side walls of the housing, fastening them together with screws. If it is necessary to maintain or repair the light fixture, all the screws on the four borders must be unscrewed and the four borders must be individually opened up before the light fixture can be opened up. This assembly method is complicated, time-consuming and labor-intensive. Alternatively, a metal frame is installed around the bottom plate, then hinges and latches are used to mount the bottom plate onto the housing, forming a door-like structure. This method allows for the easy opening of the light structure for maintenance or repair, but there still exist the problems of a lot of parts and complex assembly; also, due to the different locations of hinges and latches of products from various manufacturers, generally only the bottom plates and light fixture housings from the same manufacturer can be matched with each other and assembled together.

### SUMMARY OF THE INVENTION

It is an object of the present invention is to provide a recessed light fixture, with a housing and bottom plate which have a simple structure and convenient assembly.

A recessed light fixture, comprising a housing and bottom plate. The housing comprises a first side wall and a second side wall opposite to the first side wall, the first side wall and the second side wall being respectively provided with a first latching portion and a second latching portion, the first latching portion is integrally formed by the first side wall. The bottom plate comprises a first edge and a second edge opposite to the first edge, at least a portion of the first edge and at least a portion of the second edge are respectively engaged with the first latching portion and the second latching portion, thereby assembling the bottom plate onto the housing. The first side wall and the second side wall of the housing are opposite in position and extend substantially downward from the upper substrate. The first side wall and the second side wall are generally in the form of a flat plate or have a certain curvature. In an embodiment, the first side wall and the second side wall are structurally symmetrical, and more specifically, the first side wall and the second side wall are structurally symmetrical flat plates.

The first latching portion is integrally formed by the first side wall. Specifically, the first latching portion protrudes from the lower part of the first side wall to the outside of the housing, and the first latching portion has an opening with a U-shaped cross-section that is generally facing the housing's internal space. In one embodiment, the lower part of the first side wall is laterally continuous with the lower part of the first side wall projecting outwardly of the housing, to form a long sliding groove extending through the lower part of the first side wall, that is, the first latching portion. In an embodiment, the sliding groove extends in the horizontal direction. In a second embodiment, the lower part of the first side wall comprises at least one hanging part suspended from the lower edge of the first side wall, the hanging part has a width that is less than the whole width of the first side wall, and the at least one hanging part protrudes to the outside of the housing to form at least one hook, which is the first latching portion.

The second latching portion may be integrally formed by the second side wall. In addition, the second latching portion may also be one or more separate components coupled with the lower edge of the second side wall, either by welding or using a connector. The connector may be either a screw, rivet, clip, tab and hole fastener, hook or loop fastener. In an embodiment, the second latching portion has the same structure as the first latching portion, and they are symmetrical to each other.

In an embodiment, the housing of the recessed light fixture further comprises an upper substrate, the first side wall, and a second side wall, with the first and second side wall extending substantially downward from the upper substrate. More specifically, the housing further comprises a third side wall, and a fourth side wall opposite to the third side wall, with the upper substrate, the first side wall, the second side wall, the third side wall and the fourth side wall all forming a box-type structure that has a downward-facing opening. In one embodiment, the box-type structure is integrally formed or assembled in advance. In this case, the first edge and the second edge of the bottom plate are respectively inserted into the first latching portion and second latching portion of the first side wall and the second side wall, thereby realizing the coupling between the bottom plate and the housing. In an embodiment, the third side wall is provided with a third latching portion, the bottom plate further comprises a third edge, and at least a part of the third edge can be engaged with the third latching portion to achieve a closer coupling between the bottom plate and the housing. In a second embodiment, the upper substrate, the first side wall, the second side wall and the third side wall are integrally formed or have been assembled in advance, and the fourth side wall is detachable from the housing. In this case, the bottom plate should be installed first, the bottom plate should be engaged with the first, the second and the third latching portions to be fixed, and then the fourth side wall should be installed. In an embodiment, the fourth side wall is provided with a fourth latching portion, with the bottom plate further comprising a fourth edge, where at least a portion of the fourth edge can be engaged with the fourth latching portion. After the fourth side wall is installed, the bottom plate is also fixed by the fourth latching portion to achieve a closer coupling between the bottom plate and the housing.

The third or fourth latching portion has the function of engaging with at least a part of the edge of the bottom plate, and may be integrally formed by the corresponding side wall or one or more separate components coupled with the second side wall, either by welding or using a connector. The connector may be either a screw, rivet, clip, tab and hole fastener, hook or loop fastener. In an embodiment, the third latching portion and the fourth latching portion have the same structure and are symmetrical to each other. Optimally, the first, second, third and fourth latching portions all have the same structure.

The bottom plate may include a lens, such as a light diffusion plate, or a grid, such as a ventilation plate, according to functional requirements. The bottom plate can be borderless, or it can have borders. The thickness of the edges of the bottom plate is smaller than the opening width of the corresponding latching portion, that is, the opening width of the U-shaped cross section, so as to ensure that the edges of the bottom plate can be engaged with or inserted into the corresponding latching portion. In addition, the bottom plate is generally a substantially flat plate, but may have a certain curvature depending on the shape of the light fixture.

### BRIEF DESCRIPTION OF THE DRAWINGS

FIG. 1 is a perspective view of an assembly process according to a first embodiment of the present invention;

FIG. 2 is a bottom view of a first embodiment according to the present invention;

FIG. 3 is a cross-sectional view taken along line A-A in FIG. 2;

FIG. 4 is a partially enlarged view of part B shown in FIG. 3;

FIG. 5 is a perspective view of an assembly process according to a second embodiment of the present invention;

FIG. 6 is a bottom view of a second embodiment of the present invention;

FIG. 7 is a cross-sectional view taken along line C-C in FIG. 2;

FIG. 8 is a partially enlarged view of portion D shown in FIG. 7;

FIG. 9 is a bottom view of a third embodiment according to the present invention;

FIG. 10 is a sectional view taken along line E-E of FIG. 9,

FIG. 11 is a partially enlarged view of part F shown in FIG. 10;

FIG. 12 is a bottom view of a fourth embodiment of the present invention;

FIG. 13 is a cross-sectional view taken along line G-G of FIG. 12;

FIG. 14 is a partially enlarged view of portion H shown in FIG. 13.

### DETAILED DESCRIPTION

The present invention is further described in detail below with reference to the accompanying drawings and specific embodiments.

### First Embodiment

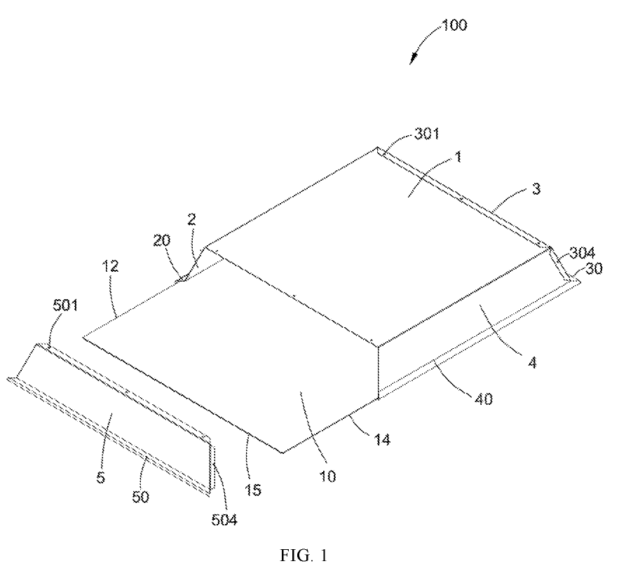

FIG. 1 shows a perspective view of an assembly process of a recessed light fixture 100 according to a first embodiment of the present invention. The recessed light fixture comprises a housing and a bottom plate 10. The housing comprises an upper substrate 1, an opposing first side wall 2 and a second side wall 4, an opposing third side wall 3 and a fourth side wall 5, and the lower parts of the four side walls 2, 3, 4, 5, respectively, having a long sliding groove 20, 30, 40, 50 protruding to the outside of the housing, respectively. The sliding grooves 20, 30, 40, 50 are integrally formed by four side walls 2, 3, 4, 5, respectively, in order to engage with the four edges 12, 13, 14, 15. The first side wall 2 and the second side wall 4 are integrally formed with the upper substrate 1. The third side wall 3 is then coupled with the upper substrate 1 by a screw 301, coupled with the first side wall 2 by screws 302 (not shown), coupled with the second side wall 4 by screws 304. Next, the two opposite edges 12, 14 of the bottom plate 10 are respectively inserted into the sliding grooves 20, 40 until the third edge 13 of the bottom plate 10 (not shown) is engaged with the sliding groove 30, and finally the fourth side wall 5 is installed. The fourth side wall 5 is coupled with the upper substrate 1 through the screw 501, coupled with the first side wall 2 by the screw 502 (not shown), coupled with the second side wall 4 by the screw 504. In this way, the four edges 12, 13, 14, and 15 of the bottom plate 10 are respectively engaged with the sliding grooves 20, 30, 40, and 50 and are prevented from moving up and down, thereby realizing a tight coupling between the bottom plate 10 and the housing.

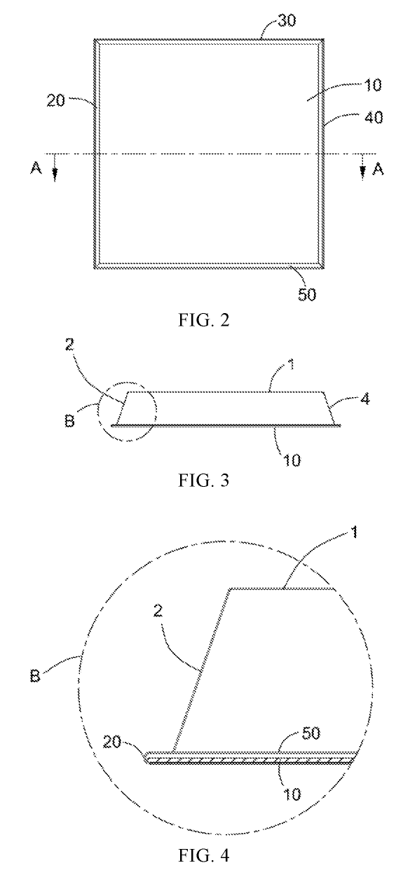

FIG. 2 shows a bottom view of the recessed light fixture 100 after the assembly is complete, with only the lower half of the bottom plate 10 and the four sliding grooves 20, 30, 40, 50 visible. FIG. 3 is a cross-sectional view taken along line A-A in FIG. 2. From a partially enlarged view of part B (FIG. 4), it can be seen that the cross-section of the sliding groove 20 is U-shaped, with the thickness of the rim of the bottom plate 10 being smaller than the U-shaped opening so that it can be engaged therein.

The first side wall 2 and the second side wall 4 may also be individual components that are separated from the upper substrate 1 and coupled with the third side wall 3, the fourth side wall 5 and the upper substrate 1 by screws.

During the assembly process, when the upper substrate 1, the first sidewall 2, and the second sidewall 4 are completely coupled, they may be assembled in the order of the bottom plate 10, the third sidewall 3, and the fourth sidewall 5. First, the two opposite edges 12 and 14 of the bottom plate 10 are inserted into sliding grooves 20 and 40, respectively, then third side wall 3 is mounted by screws, and finally the fourth side wall 5 is also mounted by screws.

As another embodiment, the upper substrate 1, the first sidewall 2, the second sidewall 4, the third sidewall 3 and the fourth sidewall 5 may be integrally formed. In this case, at least one side wall of the third sidewall 3 and the fourth side wall 5 does not have a sliding groove so that the bottom plate 10 can be inserted into the sliding grooves 20, 40, to achieve the assembly of the bottom plate 10 and the housing.

### Second Embodiment

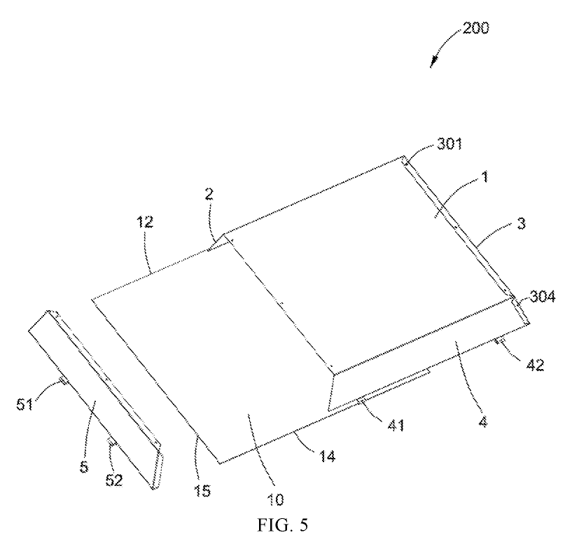

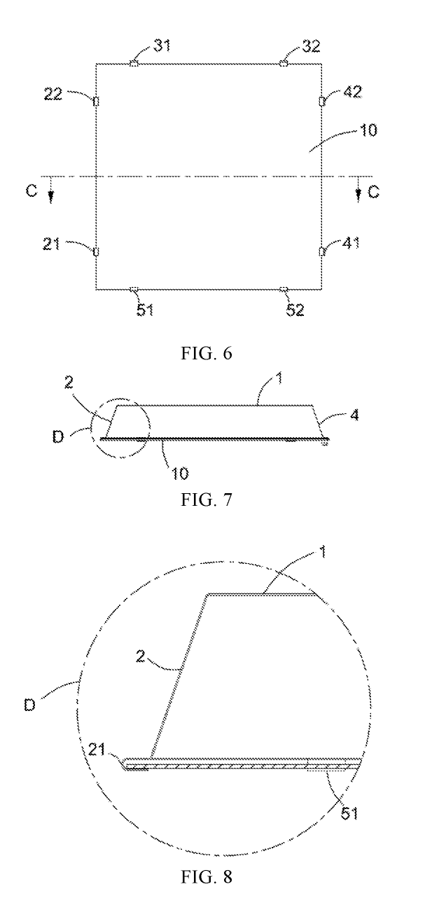

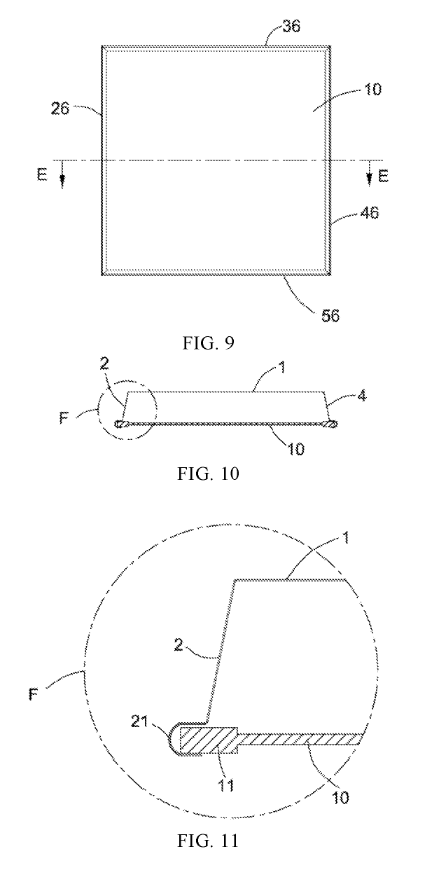

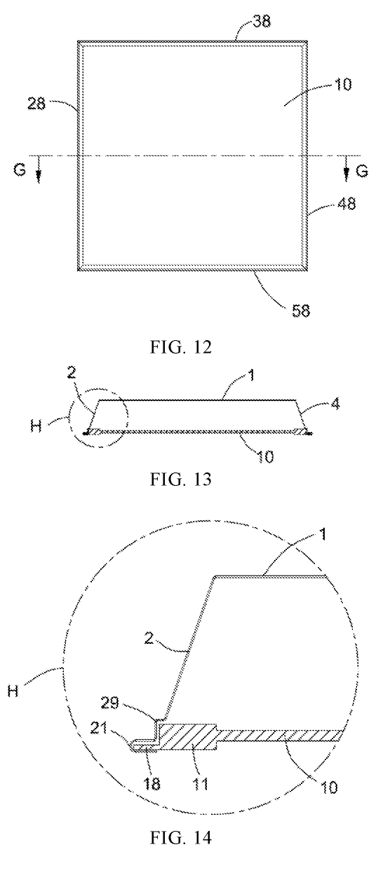

FIG. 5 shows a perspective view of the assembly process of the recessed light fixture 200 according to the second embodiment of the present invention. The recessed light fixture is similar to the first embodiment and comprises a housing and a bottom plate 10. The housing comprises an upper substrate 1, the first side wall 2, the second side wall 4, as well as the opposite third side wall 3 and the fourth side wall 5. The difference is that, the lower parts of the four side walls 2, 3, 4 and 5 are not equipped with sliding grooves, but instead have two hooks 21, 22, 31, 32, 41, 42 and 51, 52 hanging from the lower edge of the side walls for engaging with the bottom plate 10. Each of the hooks has the same structure and is integrally formed by the respective side walls thereof. The hanging portions of the lower edges of the side walls protrude outward from the housing and have a U-shaped cross section (as shown in a partially enlarged view in FIG. 8), with the U-shaped opening facing the housing interior space. As shown in FIG. 6, in this embodiment the widths of the eight hooks 21, 22, 31, 32, 41, 42, 51, and 52 are the same, which are smaller than the overall width of the side walls where the hooks are located.

As another embodiment, the number of hooks on each of the four side walls 2, 3, 4 and 5, as well as the width and the specific position of each hook may vary. As long as the bottom plate 10 and the housing are tightly coupled such that the bottom plate 10 is prevented from moving up and down. In general, the greater the number of hooks and the greater the width, the stronger the coupling between the bottom plate 10 and the housing.

### Third Embodiment

The recessed light fixture 300 of the third embodiment has a structure similar to that of the first embodiment 100, with the lower part of the four side walls of the housing having a long sliding groove 26, 36, 46, 56 protruding to the outside of the housing. The difference is that the bottom plate 10 of the recessed light fixture 300 has a border 11, therefore the four edges 12, 13, 14, and 15 of the bottom plate 10 are thicker. To cope with the thicker edges of the bottom plate 10, the U-shaped openings of the four sliding grooves 26, 36, 46, 56 are larger than the U-shaped openings of the sliding grooves in the first embodiment 100, so that the bottom plate 10 with the border 11 may be inserted into the sliding groove.

### Fourth Embodiment

The recessed light fixture 400 of the fourth embodiment comprises a housing and a bottom plate 10, with the bottom plate 10 having the same structure as the third embodiment, including the border 11, making the four edges 12, 13, 14, 15 of the bottom plate 10 thicker. In order to overcome the problem that the edges of the bottom plate 10 are thicker in the present embodiment, a thinner edge 18 is added on the outer side of the border 11 of the bottom plate 10, and the thinner edge 18 can be inserted into the sliding groove to couple the bottom plate 10 with the housing. As an embodiment, the thinner edge 18 is formed by connecting an L-shaped metal piece with the border 11. At the same time, since the side walls are inclined, a right-angle structure, such as the right-angle structure 29 in the partially enlarged view, can be formed above the sliding grooves of each side wall so as to ensure that the bottom plate 10 with a border 11 can be inserted.

While the present invention has been described in detail with reference to specific embodiments thereof, it will be understood by those skilled in the art that many modifications and variations can be made in the present invention. It is, therefore, to be understood that the appended claims are intended to cover all such modifications and variations insofar as they are within the true spirit and scope of the invention.

1. A recessed light fixture, comprising:
a housing, comprising a first side wall, and a second side wall opposite to the first side wall, the first and the second side walls being provided with a first and second latching portion respectively, where the first latching portion is formed integrally from the first side wall; and
a bottom plate comprising a first edge, and a second edge opposite to the first edge, at least a portion of the first and second edges engaged with the first and second latching portions respectively, thereby assembling the bottom plate onto the housing.

2. The recessed light fixture according to claim 1, wherein the first latching portion is formed from the protrusion of the lower part of the first side wall towards the outside of the housing, where the first latching portion's opening has a U-shaped cross section facing the inside of the housing.

3. The recessed light fixture from claim 2, wherein the first latching portion is a long sliding groove extending through lower part of the first side wall.

4. The recessed light fixture from claim 2, wherein the first latching portion consists of at least one hook hanging from a lower edge of the first side wall, with the hook comprising a U-shaped cross section.

5. The recessed light fixture from claim 1, wherein the second latching portion is structurally symmetrical to the first latching portion.

6. The recessed light fixture according to claim 1, wherein the housing further comprises an upper substrate, with the first side wall and the second side wall both extending in a generally downward direction from the upper substrate.

7. The recessed light fixture according to claim 6, wherein the housing further comprises a third side wall and a fourth side wall opposite to the third side wall, with the upper substrate, the first side wall, the second side wall, the third side wall, and the fourth side wall forming a box structure.

8. The recessed light fixture according to claim 7, wherein the third side wall is provided with a third latching portion, the bottom plate further comprises a third edge, with at least a portion of the third edge being able to engage with the third latching portion.

9. The recessed light fixture of claim 7, wherein at least one of the third side wall or the fourth side wall is detachable from the housing.

10. The recessed light fixture according to claim 9, wherein the fourth side wall is provided with a fourth latching portion, the bottom plate further comprises a fourth edge, with at least a portion of the fourth edge being able to engage with the fourth latching portion.

11. The recessed light fixture according to claim 1, wherein the bottom plate can be inserted into the first and second latching portions to prevent the bottom plate from moving up and down.
